(19) United States
(12) Patent Application Publication
(10) Pub. No.: US 2013/0016929 A1
(43) Pub. Date: Jan. 17, 2013

(54) SLIDE ASSEMBLY

(71) Applicants: CHEN-LU FAN, Tu-Cheng (TW); JING-CHAO LIANG, Shenzhen City (CN)

(72) Inventors: CHEN-LU FAN, Tu-Cheng (TW); JING-CHAO LIANG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD ., Shenzhen City (CN)

(21) Appl. No.: 13/483,226

(22) Filed: May 30, 2012

(30) Foreign Application Priority Data
Jul. 13, 2011 (CN) 201110195700.7

(51) Int. Cl. F16C 17/26

(52) U.S. Cl. 384/35

(57) ABSTRACT

A slide assembly includes a middle slide, an inner slide mounted on the middle slide, and a locking member mounted on the inner slide. Two abutting portions extended from a first end of the locking slice. A blocking portion is formed on a second end of the locking slice. Two connecting slots are defined in the middle slide correspond to the two abutting portions. When the inner slide is slid out of the middle slide, the two abutting portions abut a first side edge of each of the two connecting slots to prevent the inner slide being slid out continuously. When the inner slide is slid back to the middle slide, the blocking portion abuts a first end of the middle slide to prevent the inner slide being slid back.

### BACKGROUND

1. Technical Field

The present disclosure relates to a slide assembly for protecting an electronic device from shocking impacts.

2. Description of Related Art

Three-section slides for server units include an inner slide, an outer slide, and a third slide. A slide-aiding ball member is sandwiched between any two of the inner slide, the outer slide, and the third slide to enable a smooth sliding movement. The inner slide and the outer slide have a retaining member and a stop member mounted thereon respectively, for restricting movement. The retaining member is attached to an inner surface of the inner slide, and is provided with an engaging portion. The stop member is mounted to a front end of the outer slide, and is provided with a protrusion. When users draw out the inner slide from the outer slide, the protrusion of the stop member engages with the engaging portion of the retaining member to prevent accidental disassembling of the inner slide from the outer slide.

However, the inner slide may withstand impact forces by the outer slide and the third slide when the user directly disengages the engaging portion from the stop member to let the inner slide retract into the outer slide. Therefore, it may be inconvenient and dangerous for users to operate the slides.

Therefore there is a need for improvement in the art.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an assembly view of an embodiment of a slide assembly for mounting an electronic device, the slide assembly including a locking member, an outer slide, a middle slide, an inner slide and a handle member.

FIG. 2 is an exploded, isometric view of the locking member, the middle slide and the inner slide of FIG. 1.

FIG. 3 is an isometric view of the locking member of FIG. 2.

FIG. 4 is an assembly view of the locking member, the middle slide and the inner slide of FIG. 2.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

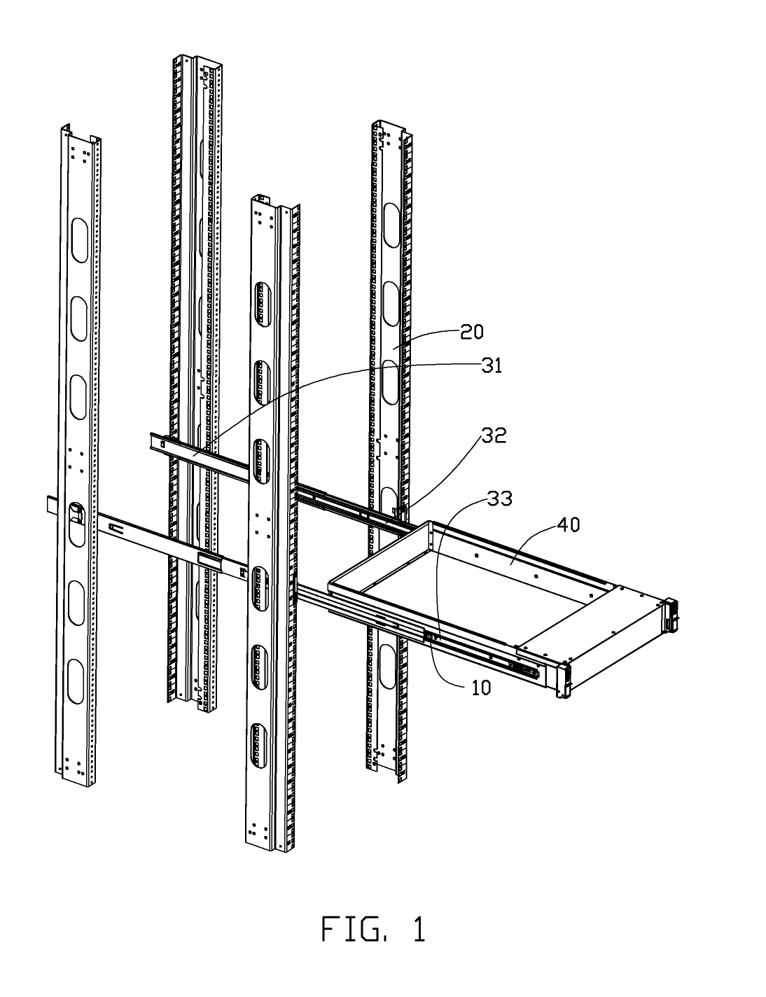

Referring to FIG. 1, a slide assembly in accordance with an embodiment, configured for mounting an electronic device 40, includes a locking member 10, an outer slide 31 mounted on a rack 20, a middle slide 32 mounted on the outer slide 31, and an inner slide 33 mounted on the middle slide 32.

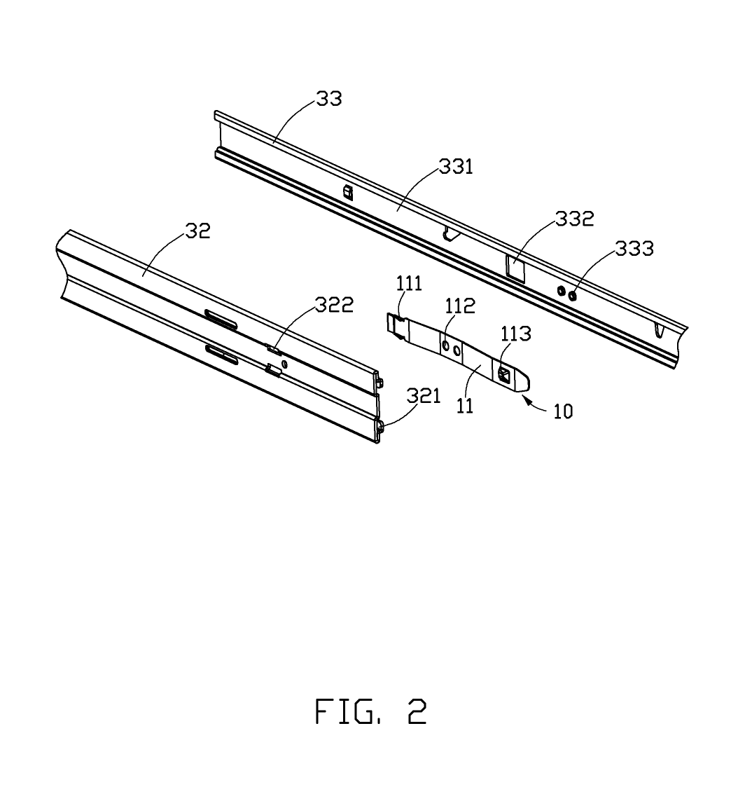

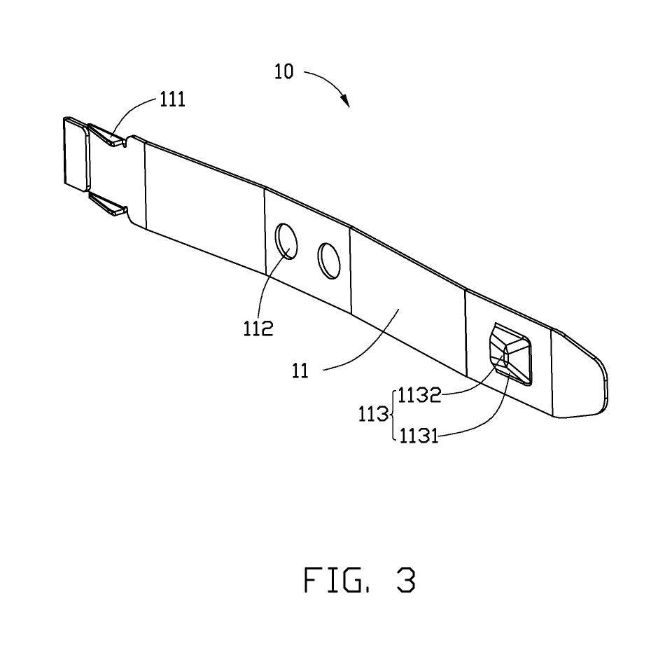

Referring to FIGS. 2 and 3, the locking member 10 includes a locking slice 11. Two triangular-shaped abutting portions 111 perpendicularly extended from two edges on a first end of the locking slice 11. Two circular mounting holes 112 are defined in a middle portion of the locking slice 11. A trapezoid-shaped blocking portion 113 is formed on a second end of the locking slice 11. The blocking portion 113 includes three trapezoid-shaped sidewalls 1131 extended from the locking slice 11 and a trapezoid-shaped top wall 1132 connected among the three sidewalls 1131. The first end and the second end of the locking slice 11 are bent and tilted slightly. In one embodiment, the locking slice 11 is an elastic slice. A width of the first end and the second end of the locking slice 11 is less than a width of the middle portion of the locking slice 11. The two abutting portions 111 are right triangular-shaped.

Two side edges of the middle slide 32 are bent to form a first fixing slot 321 for receiving the inner slide 33. Two rod-shaped connecting slots 322 are defined in the first fixing slot 321 corresponding to the two abutting portions 111. Two side edges of the inner slide 33 are bent to form a second fixing slot 331 for receiving the locking slice 11. A rod-shaped opening 332 is defined in the second fixing slot 331 corresponding to the first end of the locking slice 11. Two column-shaped mounting portions 333 are formed in the second fixing slot 331 corresponding to the two mounting holes 112.

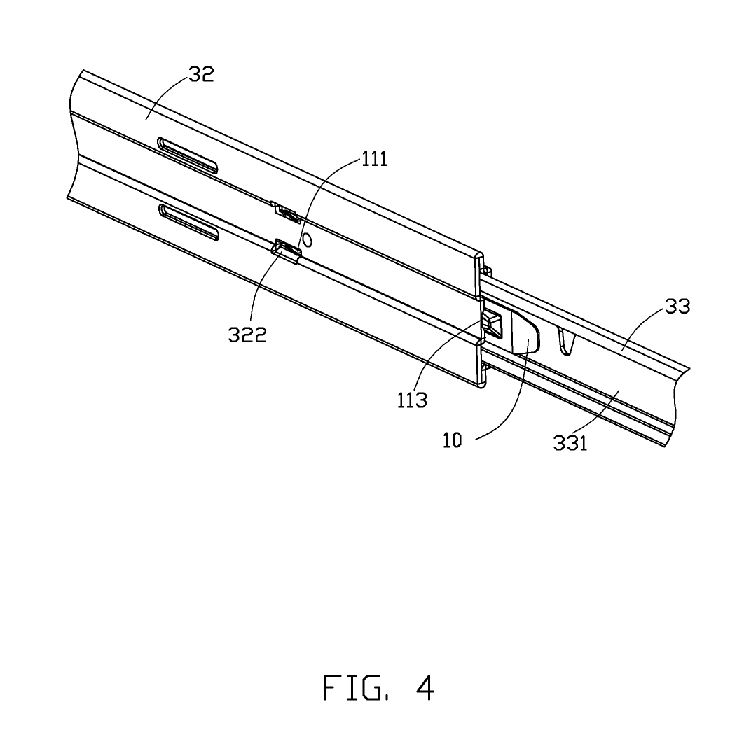

Referring to FIG. 4, in assembly, the two mounting portions 333 are passed through the two mounting holes 112 to mount the locking slice 11 in the second fixing slot 331. The first end of the locking slice 11 aligns with the opening 332. The inner slide 33 is mounted in the first fixing slot 321. Thus, the locking member 10 and the inner slide 33 are fixed on the middle slide 32. When the electronic device 40 is slid out from the inner slide 33, the middle slide 32 and the inner slide 33 are slid out of the rack 20 sequentially. The two abutting portions 111 of the locking slice 11 are slid in the two connecting slots 322. A first end of each of the two abutting portions 111 abuts a first side edge of each of the two connecting slots 322 to prevent the inner slide 33 being slid out of the rack 20 continuously. Opposite two of the three sidewalls 1131 of the blocking portion 113 abut a first end of the middle slide 32 to prevent the inner slide 33 being slid back in the rack 20.

When the electronic device 40 is slid back to the rack 20, the inner slide 33 and the middle slide 32 are slid back sequentially. The second end of the locking slice 11 is pressed toward the second fixing slot 331. Opposite two of the three sidewalls 1131 of the blocking portion 113 doe not abut the first end of the middle slide 32. A second end of each of the two abutting portions 111 slides along a second side edge of each of the two connecting slots 322. The inner slide 33 is slid back to the rack 20.

Even though numerous characteristics and advantages of the present disclosure have been set forth in the foregoing description, together with details of the structure and function of the disclosure, the disclosure is illustrative only, and changes may be made in detail, especially in the matters of shape, size, and arrangement of parts within the principles of the disclosure to the full extent indicated by the broad general meaning of the terms in which the appended claims are expressed.

What is claimed is:

1. A slide assembly, comprising:
a middle slide;
an inner slide mounted on the middle slide; and
a locking member mounted on the inner slide and comprising a locking slice;
wherein two abutting portions extend from a first end of the locking slice; a blocking portion is formed on a second end of the locking slice; two connecting slots are defined in the middle slide, each of the two connecting slots corresponding to each of the two abutting portions; when the inner slide is slid out of the middle slide, each of the two abutting portions abuts a first side edge of each of the two connecting slots to prevent the inner slide from being slid out; and when the inner slide is being slid back to the middle slide, the blocking portion abuts a first end of the middle slide to prevent the inner slide from sliding back out of the middle slide.

2. The slide assembly of claim 1, wherein the blocking portion comprises three trapezoid-shaped sidewalls extended from the locking slice and a trapezoid-shaped top wall connected to each of the three sidewalls; and opposite two of the three sidewalls abut the first end of the middle slide when the inner slide is being slid back.

3. The slide assembly of claim 1, wherein the two abutting portions are right-angled triangular-shaped; a first end of each of the two abutting portions abuts a first side edge of each of the two connecting slots when the inner slide is being slid out.

4. The slide assembly of claim 1, wherein each two side edges of the middle slide is bent to form a first fixing slot for receiving the inner slide; and each two side edges of the inner slide is bent to form a second fixing slot for receiving the locking slice.

5. The slide assembly of claim 4, wherein two mounting holes are defined in a middle portion of the locking slice; two mounting portions are formed in the second fixing slot, each of the two mounting portions corresponding to each of the two mounting holes; and
each of the two mounting portions passes through each of the two mounting holes to mount the locking slice in the second fixing slot.

6. The slide assembly of claim 4, wherein an opening is defined in the second fixing slot, the opening corresponding to the first end of the locking slice; the second end of the locking slice is pressed toward the second fixing slot; the blocking portion does not abut a first end of the inner slide; a second end of each of the two abutting portions slides along a second side edge of each of the two connecting slots; the first end of the locking slice moves toward the opening; and the inner slide is being slid back.

7. The slide assembly of claim 6, wherein the locking slice is an elastic slice; and the first end and the second end of the locking slice are bent and tiled.

8. The slide assembly of claim 6, wherein each of a width of the first end and a width of the second end of the locking slice is less than a width of the middle portion of the locking slice.

9. A slide assembly, comprising:
a middle slide;
an inner slide mounted on the middle slide; and
a locking member mounted on the inner slide and comprising a locking slice;
wherein two abutting portions extend from a first end of the locking slice; a blocking portion is formed on a second end of the locking slice; two connecting slots are defined in the middle slide, each of the two connecting slots corresponding to each of the two abutting portions; the locking slice is an elastic slice; the first end and the second end of the locking slice are bent and tiled; when the inner slide is slid out of the middle slide, each of the two abutting portions abuts a first side edge of each of the two connecting slots to prevent the inner slide from being slid out; and when the inner slide is being slid back to the middle slide, the blocking portion abuts a first end of the middle slide to prevent the inner slide sliding out of the middle slide.

10. The slide assembly of claim 9, wherein the blocking portion comprises three trapezoid-shaped sidewalls extended from the locking slice and a trapezoid-shaped top wall connected among the three sidewalls; and opposite two of the three sidewalls abut the first end of the middle slide when the inner slide is being slid back.

11. The slide assembly of claim 9, wherein the two abutting portions are right-angled triangular-shaped; a first end of each of the two abutting portions abuts a first side edge of each of the two connecting slots when the inner slide is being slid out.

12. The slide assembly of claim 9, wherein each of two side edges of the middle slide is bent to form a first fixing slot for receiving the inner slide; and each two side edges of the inner slide is bent to form a second fixing slot for receiving the locking slice.

13. The slide assembly of claim 12, wherein two mounting holes are defined in a middle portion of the locking slice; two mounting portions are formed in the second fixing slot, each of the two mounting portions corresponding to each of the two mounting holes; and each of the two mounting portions passes through each of the two mounting holes to mount the locking slice in the second fixing slot.

14. The slide assembly of claim 12, wherein an opening is defined in the second fixing slot, the opening corresponding to the first end of the locking slice; the second end of the locking slice is pressed toward the second fixing slot; the blocking portion does not abut a first end of the inner slide; a second end of each of the two abutting portions slides along a second side edge of each of the two connecting slots; the first end of the locking slice moves toward the opening; and the inner slide is being slid back.

15. The slide assembly of claim 14, wherein each of a width of the first end and a width of the second end of the locking slice is less than a width of the middle portion of the locking slice.
